(19) United States
(12) Patent Application Publication
(10) Pub. No.: US 2022/0109204 A1
(43) Pub. Date: Apr. 7, 2022

(54) IMPACT RESISTANT BATTERY CELL

(71) Applicant: American Lithium Energy Corporation, Carlsbad, CA (US)

(72) Inventor: Jiang Fan, San Diego, CA (US)

(21) Appl. No.: 17/492,471

(22) Filed: Oct. 1, 2021

Related U.S. Application Data
(60) Provisional application No. 63/087,012, filed on Oct. 2, 2020.

(51) Int. Cl. H01M 50/143; H01M 50/122; H01M 50/586; H01M 50/188

(52) U.S. Cl. CPC H01M 50/143; H01M 50/188; H01M 50/586; H01M 50/122

(57) ABSTRACT

A battery cell may include a jellyroll including a first electrode, a second electrode, and a separator interposed between the first electrode and the second electrode. The jellyroll may be disposed inside a case with a safety layer interposed between the jellyroll and the case. The safety layer may be configured to prevent contact between the jellyroll and the case. Moreover, the safety layer is configured to stretch to accommodate one or more deformations in the case such that the safety layer remains interposed between the jellyroll and the case when the case is bent towards the jellyroll. In doing so, the safety layer may prevent the battery cell from developing an internal short, which may occur if the case makes direct contact with the jellyroll.

### CROSS REFERENCE TO RELATED APPLICATION

This application claims priority to U.S. Provisional Application No. 63/087,012, entitled “IMPACT RESISTANT BATTERY CELL” and filed on Oct. 2, 2021, the disclosure of which is incorporated herein by reference in its entirety.

### TECHNICAL FIELD

The subject matter described herein relates generally to battery cells and more specifically to an impact resistant battery cell.

### BACKGROUND

A battery cell can overcharge, overheat, and/or short circuit during operation. For example, an overcurrent can occur when the battery cell is overcharged and/or develops an internal short circuit. Overcurrent can cause irreversible damage to the battery cell. In particular, overcurrent can lead to thermal runaway, a hazardous condition in which undissipated heat from the overheating battery cell accelerates exothermic reactions within the battery cell to further increase the temperature of the battery. The consequences of thermal runaway can be especially dire including, for example, fire, explosions, and/or the like.

### SUMMARY

According to various aspects of the current subject matter, a battery cell may include a safety layer configured to mitigate and/or eliminate the hazards that can arise during the operation of the battery cell. The safety layer may be interposed between a metal case of the battery cell and a jellyroll including a negative electrode, a separator, and a positive electrode of the battery cell. Without the safety layer, the battery cell may develop an internal short circuit when the metal case undergoes a deformation that causes at least a portion of the metal case to contact the jellyroll including, for example, the negative electrode and/or the positive electrode included in the jellyroll. Contrastingly, interposing the safety layer between the metal case and the jellyroll may prevent the battery cell from developing the internal short circuit by at least preventing the deformed metal case from being in direct contact with the jellyroll.

In one aspect, there is provided a battery cell. The battery cell may include: a jellyroll including a first electrode, a second electrode, and a separator interposed between the first electrode and the second electrode; a case; and a safety layer interposed between the jellyroll and the case, the safety layer configured to prevent contact between the jellyroll and the case.

In some variations, one or more features disclosed herein including the following features can optionally be included in any feasible combination. The safety layer may be configured to stretch to accommodate one or more deformations in the case such that the safety layer remains interposed between the jellyroll and the case when the case is bent towards the jellyroll.

In some variations, the safety layer may include one or more of polyhedral oligomeric silsesquioxane (POSS), poly imide amide, carboxymethyl cellulose (CMC), crosslinked polycrylic acid, sodium metasilicate nonahydrate, silicone, urethane, acrylic, and Kevlar.

In some variations, the safety layer may include a conductive additive.

In some variations, the conductive additive may include carbon black.

In some variations, the safety layer may include a fire retardant.

In some variations, the fire retardant may include one or more of calcium carbonate (CaCO₃), sodium carbonate (NaCO₃), and terphenyl phosphate.

In some variations, the safety layer may include a binder.

In some variations, the binder may include polyvinylidene fluoride (PVDF).

In some variations, the safety layer may include a solvent.

In some variations, the binder may include one or more of water and N-Methyl-2-pyrrolidone (NMP).

In some variations, the safety layer may include a first layer and a second layer. The first layer may be interposed between an interior surface of the case and the second layer. The first layer may be configured to release water while the second layer may be configured to make direct contact with an electrolyte included in the battery cell.

In some variations, the first layer may be formed from a different solvent than the second layer.

In some variations, the first layer may include sodium metasilicate nonahydrate dissolved in water and the second layer may include poly imide amide dissolved in N-Methyl-2-pyrrolidone (NMP).

In some variations, the safety layer may be disposed on an exterior surface of the jellyroll and/or an interior surface of the case.

In some variations, an interior surface of the case may be corrugated. The safety layer may be formed by disposing a solution of materials comprising the safety layer in one or more voids of the corrugated interior surface of the case.

In some variations, the battery cell may further include: a lid including a first pin and a second pin, the case configured to form a chamber when sealed with the lid, the jellyroll being disposed inside the chamber, the jellyroll including a negative electrode tab configured to couple with the first pin to form a negative terminal of the battery cell, and the jellyroll further including a positive electrode tab configured to couple with the second pin to form a positive terminal of the battery cell; and a gasket configured to at least partially encase each of the negative electrode tab and the positive electrode tab to prevent a contact between the negative electrode tab, the positive electrode tab, and/or the case of the battery cell.

In some variations, the battery cell may further include: a first current collector coupled with the first electrode; a second current collector coupled with the second electrode; and an electrolyte.

In some variations, the battery cell may be a cylindrical cell, a prismatic cell, a pouch cell, or a button cell.

In some variations, the first electrode and/or the second electrode comprise a poly-p-phenylene terephthalamide or an aramid dissolved in a polyhedral oligomeric silsesquioxane (POSS).

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a schematic diagram illustrating an example of a battery cell consistent with implementations of the current subject matter;

FIG. 2 depicts a schematic diagram illustrating an example of a battery cell consistent with implementations of the current subject matter; and

FIG. 3 depicts a flowchart illustrating a process for assembling a battery cell consistent with implementations of the current subject matter.

When practical, similar reference numbers denote similar structures, features, or elements.

### DETAILED DESCRIPTION

A battery cell may include a metal case containing a jellyroll (or jellyflat) formed to include a negative electrode, a separator, and a positive electrode of the battery cell. However, the battery cell may develop an internal short circuit when the metal case undergoes a deformation that causes at least a portion of the metal case to contact the jellyroll including, for example, the negative electrode and/or the positive electrode included in the jellyroll. As noted, the internal short circuit at the battery cell may give rise to an overcurrent capable of causing irreversible damage to the battery cell. The overcurrent may further lead to a thermal runaway, at which point the overheating battery cell may cause a fire and/or an explosion.

To avoid the battery cell from developing an internal short circuit and to mitigate the concomitant consequences, in some implementations of the current subject matter, the battery cell may include a safety layer interposed between the metal case of the battery cell and the jellyroll including the negative electrode, the separator, and the positive electrode of the battery cell. The safety layer interposed between the metal case and the jellyroll may prevent the battery cell from developing the internal short circuit by at least preventing the deformed metal case from making direct contact with the jellyroll.

In some implementations of the current subject matter, the safety layer may be further configured to mitigate and/or eliminate other operational hazards associated with the battery cell including, for example, overcharging, overheating, and/or the like. For example, the safety layer may be configured to respond to the battery cell overheating by interrupting a flow of current within the battery cell including by undergoing a phase transition that causes the safety layer to expand and/or contract. The expansion and/or contraction of the safety layer can cause an electric decoupling within the battery cell, for example, between an electrode of the battery cell and a corresponding current collector. It should be appreciated that the electric decoupling can interrupt the flow of current within the battery cell, thereby arresting exothermic reactions within the battery cell and any further increase in the temperature of the battery cell.

In some implementations of the current subject matter, the safety layer may be interposed between the metal case and the jellyroll by coating, spraying, and/or depositing, on an interior surface of the metal case and/or an exterior surface of the jellyroll, one or more layers of the material forming the safety layer. For example, one or more layers of the material forming the safety layer may be disposed on the surface of the metal case and/or the surface of the jellyroll by coating including, for example, micro-gravure coating, slot die coating, reverse roll coating, and/or the like. Alternatively and/or additionally, one or more layers of the material forming the safety layer may be disposed on the surface of the metal case and/or the surface of the jellyroll by spraying and/or deposition including, for example, vapor deposition, electron beam deposition, ion assistant deposition, atomic layer deposition, and/or the like.

In some implementations of the current subject matter, the safety layer disposed on the surface of the metal case and/or the surface of the jellyroll may be subjected to one or more treatments. For instance, the safety layer may be subject to a drying treatment to remove solvent and/or a cross-linking treatment to rigidify the material forming the safety layer. Alternatively and/or additionally, the safety layer can further be subject to a chemical treatment, a heat treatment, and/or a radiation treatment (e.g., exposure to ultraviolet (UV) light, β-ray, X-ray, and/or the like).

In some implementations of the current subject matter, a safety layer may be formed from a polyhedral oligomeric silsesquioxane (POSS), which is a nanostructured chemical that bridges the gap between ceramic and organic materials. It should be appreciated that polyhedral oligomeric silsesquioxane may improve the performance of the safety layer without any compromise to the mechanical properties of the safety layer.

In some implementations of the current subject matter, the case of the battery cell may be configured to provide additional safety mechanisms including, for example, resistance to heat, fires, penetration, and/or the like. For example, the case of the battery cell may be formed from one or more of a fire retardant material, an impact resistant material such as a fiber like poly-paraphenylene terephthalamide (or aromatic polyamides) (e.g., Kevlar), a ceramic, a phase change material, a shear thickening material, and/or a thermal insulator.

In some implementations of the current subject matter, the aromatic polyamides can be dissolved into a solution before being mixed with polyhedral oligomeric silsesquioxane (POSS), an electrode binder, a conductive additive, and an electrode active to form an electrode slurry. The electrode slurry can be coated onto the current collector and the dried to form a strong electrode that can be resistive against impact and/or penetration. The polyhedral oligomeric silsesquioxane (POSS) can be cross-linked to the binders and/or the polymers including the aromatic polyamides by exposure to ultraviolet (UV) light. The combination of polyhedral oligomeric silsesquioxane (POSS) and aromatic polyamides can function as mechanical strength enhancers for the electrodes, thus lending additional protection against the impact and penetration in a battery cell incorporating the electrodes.

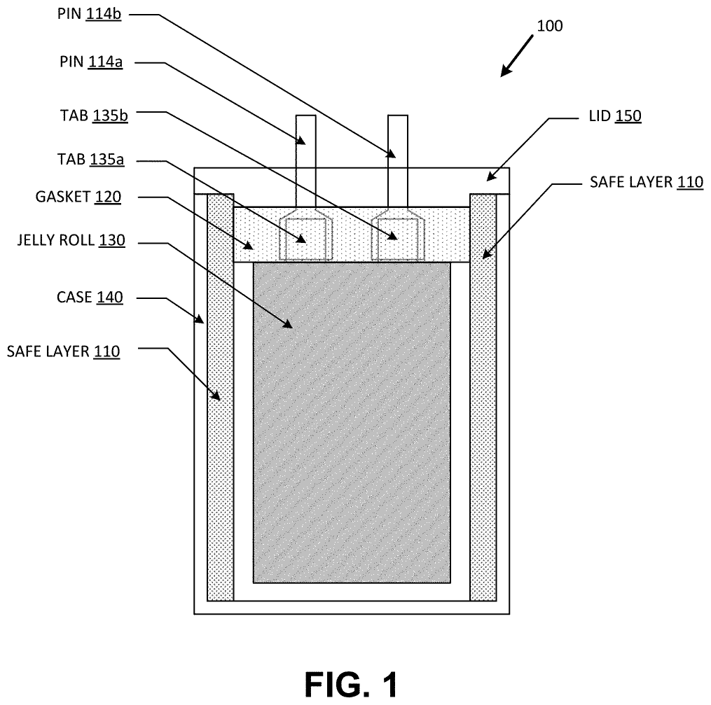

FIG. 1 depicts a schematic diagram illustrating an example of a battery cell 100 consistent with implementations of the current subject matter. Referring to FIG. 1, the battery cell 100 may include a jellyroll 130 that is disposed inside a case 140 sealed by a lid 150. In some configurations of the battery cell 100, the open top of the case 140 may include a flange extending beyond the side walls of the case 140 whereas in other configurations of the battery cell 100, the sidewalls of the case 140 may be flush. The battery cell 100 may be any type of battery cell including, for example, a lithium ion battery cell, a sodium ion battery cell, and/or the like. The battery cell 100 may be a non-rechargeable primary battery cell or a rechargeable secondary battery cell. Moreover, although the example of the battery cell 100 shown in FIG. 1 is a prismatic battery cell, it should be appreciated that the battery cell 100 may have a different format including, for example, a button battery cell, a cylindrical cell, a pouch cell, and/or the like.

As shown in FIG. 1, the battery cell 100 may include a first electrode tab 135a and a second electrode tab 135b extending from the jellyroll 130. For example, the first electrode tab 135a may be a negative electrode tab coupled with a negative electrode included in the jellyroll 130 while the second electrode tab 135b may be a positive electrode tab coupled with a positive electrode included in the jellyroll 130. Each of the negative electrode and the positive electrode may be further coupled with a corresponding current collector while a separator may be interposed between the negative electrode and the positive electrode. The electrode tabs 135 may be formed from a metal and/or a metal alloy including, for example, aluminum (Al), titanium (Ti), platinum (Pt), gold (Au), and/or the like. In the example of the battery cell 100 shown in FIG. 1, the first electrode tab 135a and the second electrode tab 135b may be coupled with a first pin 114a and a second pin 114b extending through the lid 150 of the battery cell 100, for example, through feedthroughs in the lid 150 of the battery cell 100. The pins 114 may be formed from a metal and/or a metal alloy with a high melting point (e.g., >1000° C.) such as platinum (Pt), iridium (Ir), and/or the like. This coupling between the electrode tabs 135 and the pins 114 may form the terminals of the battery cell 100. In this example of the battery cell 100, the electrode tabs 135 may be electrically isolated from the case 140 of the battery cell 100 such that the case of the battery cell 100 is electrically neutral (e.g., having an overall charge of zero). Alternatively, in other configurations of the battery cell 100, the first electrode tab 135a, which may be a negative electrode tab coupled with a negative electrode included in the jellyroll 130, may be coupled with case 140 of the battery cell 100, for example, by being welded to one or more surfaces of the case 140, thus lending the case 140 with a negative electrical charge.

In some implementations of the current subject matter, a safety layer 110 may be interposed between the jellyroll 130 and the case 140. The safety layer 110 may be formed from a polyhedral oligomeric silsesquioxane (POSS) or another material with sufficient elasticity and flexibility to accommodate various deformations in the case 140 of the battery cell 100. One or more layers of the material forming the safety layer 110 may be disposed on an exterior surface of the jellyroll 130 and/or an interior surface of the case 140 by coating (e.g., micro-gravure coating, slot die coating, reverse roll coating), spraying, deposition (e.g., vapor deposition, electron beam deposition, ion assistant deposition, atomic layer deposition), and/or the like. Moreover, in some cases, the one or more layers of material forming the safety layer 110 may be subjected to one or more treatments including, for example, a drying treatment to remove solvent, a cross-linking treatment to rigidify the material forming the safety layer 110, a chemical treatment, a heat treatment, a radiation treatment (e.g., exposure to ultraviolet (UV) light, β-ray, X-ray), and/or the like.

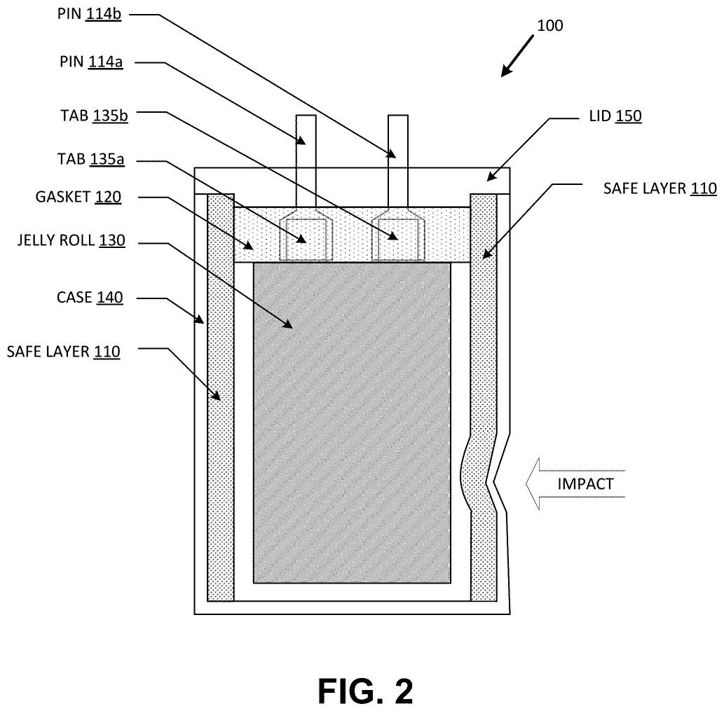

As shown in FIG. 2, the case 140 may be deformed in a manner that causes the case 140 to bend towards the jellyroll 130. The safety layer 110 may be configured to accommodate the deformation without exhibiting structural failures such as cracks, tears, and/or the like. In the absence of the safety layer 110 interposed between the jellyroll 130 and the case 140, the case 140 may make direct contact with the jellyroll 130 to cause an internal short circuit within the battery cell 100. The internal short circuit may engender a thermal runaway in which an uncontrolled increase in the temperature of the battery cell 100 further precipitates hazards such as fires, explosions, and/or the like. By contrast, the presence of the safety layer 110 between the jellyroll 130 and the case 140 may prevent direct contact between the jellyroll 130 and the case 140. Referring again to FIG. 2, the safety layer 110 may stretch to accommodate the deformation present in the case 140, thus remaining interposed between the jellyroll 130 and the case 140 even as the case 140 is bent towards the jellyroll 130.

Leaving the electrode tabs 135 exposed may render the battery cell 100 susceptible to developing an internal short, for example, when the first electrode tab 135a and the second electrode tab 135b come into contact with each other and/or with the case 140. However, insulating the electrode tabs 135 with conventional adhesive tape may provide inadequate protection at least because conventional adhesive tape is prone to degradation over time. Accordingly, in the example shown in FIGS. 1-2, the battery cell 100 may include one or more mechanisms for extending the longevity of the battery cell 100 including, for example, a gasket 120 configured to insulate the electrode tabs 135 coupled with the pins 114.

In addition to insulating the electrode tabs 135 to prevent an internal short, the gasket 120 may also extend the longevity of the battery cell by protecting the battery cell 100 during manufacturing and assembly. For example, the lid 150 may be sealed to the case 140 by use of electromagnetic energy such as laser welding and/or the like. The beam of electromagnetic energy and the concomitant heat may cause inadvertent damage to the feedthroughs in the lid 150 of the battery cell 100 including by compromising the seals that are formed around the pins 114 inserted through the feedthroughs. The presence of the gasket 120 may therefore extend the longevity of the battery cell 100 by protecting the feedthroughs from being damaged by the electromagnetic energy used to seal the battery cell 100.

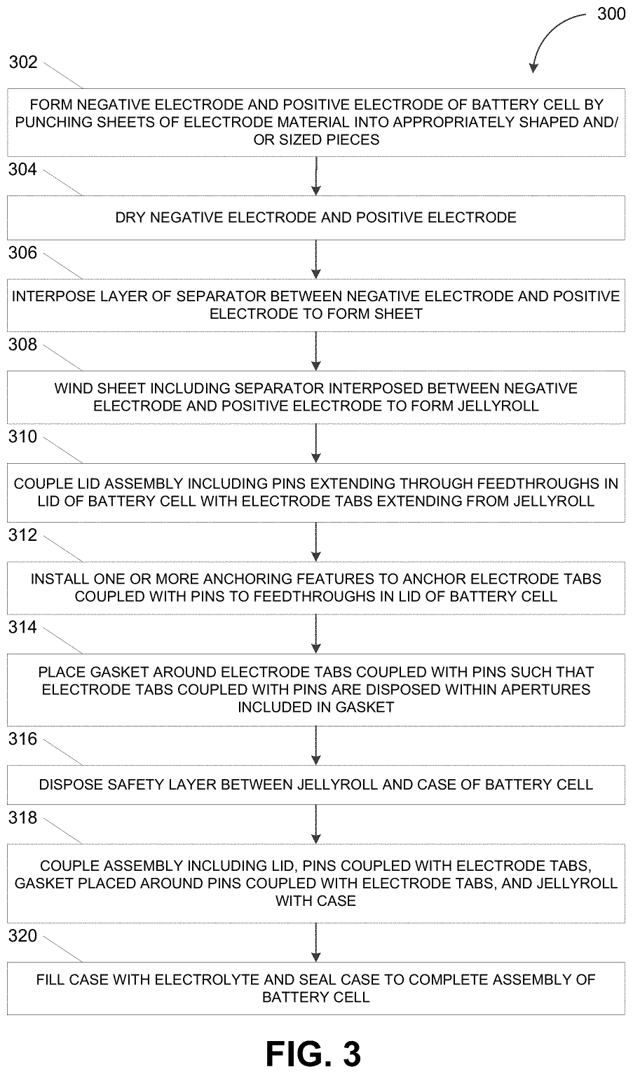

FIG. 3 depicts a flowchart illustrating a process 300 for assembling a battery cell consistent with implementations of the current subject matter. Referring to FIGS. 1-3, the process 300 may be performed in order to assemble the battery cell 100.

The negative electrode and positive electrode of the battery cell may be formed by punching sheets of electrode material into appropriately shaped and/or sized pieces (302). For instance, sheets of positive electrode material and/or negative electrode material may be punched into appropriately shaped and/or sized pieces.

The negative electrode and the positive electrode of the battery cell may be dried (304). For example, the positive electrode of the battery cell 100 may be dried at 125° C. for 10 hours while the negative electrode of the battery cell may be dried at 140° C. for 10 hours.

A layer of separator may be interposed between the positive electrode and the negative electrode to form a sheet (306). For instance, a layer of separate may be laminated the positive electrode and the negative electrode of the battery cell 100 to form a sheet.

The sheet including the separator interposed between the positive electrode and the negative electrode may be wound to form a jellyroll (308). For example, the sheet including the separator interposed between the positive electrode and the negative electrode may be wound around a mandrel to form the jellyroll 130.

A lid assembly including pins extending through feedthroughs in a lid of the battery cell may be coupled with the electrode tabs extending from the jellyroll (310). For example, the lid assembly 115, which includes the first pin 114a and the second pin 114b extending through feedthroughs in the lid 150, may be coupled with the electrode tabs 135 including by coupling the first pin 114a with the first electrode tab 135a and the second pin 114b with the second electrode tab 135b.

One or more anchoring features may be installed to anchor the electrode tabs coupled with the pins to the feedthrough in the lid of the battery cell (312). For example, the first anchoring feature 600a may be coupled with the first electrode tab 135a (and/or the first pin 114a) and the second anchoring feature 600b may be coupled with the second electrode tab 135b (and/or the second pin 114b) in order to anchor the electrode tabs 135 and the pins 114 to the feedthrough in the lid 150 of the battery cell 100. This anchoring may prevent the electrode tabs 135 and the pins 114 from be deformed during subsequent manufacturing operations such as, for example, crimping portions of the pins 114 that extend beyond the lid 150 of the battery cell 100.

A gasket may be placed around the electrode tabs coupled with the pins such that the electrode tabs coupled with the pins are disposed within apertures included in the gasket (314). For example, the gasket 120 may include the first gasket segment 120a and the second gasket segment 120b which may be at least partially detachable from one another to allow a placement of the first electrode tab 135a (and/or the first pin 114a) in the first aperture 122a and the second electrode tab 135b (and/or the second pin 114b) in the second aperture 122b. As shown in FIGS. 2-4, the first gasket segment 120a may include the first connector 124a and the second gasket segment 120b may include the second connector 124b. Once the first electrode tab 135a (and/or the first pin 114a) in disposed within the first aperture 122a and the second electrode tab 135b (and/or the second pin 114b) is disposed within the second aperture 122b, the first gasket segment 120a may be coupled with the second gasket segment 120b including by engaging the first connector 124a with the second connector 124b. Moreover, as shown in FIG. 5, the gasket 120 may include the retention feature 500 configured to lock the gasket 120 in a fixed position relative to the lid 150. For instance, the retention feature 500 may be a protrusion (e.g., a spike and/or the like) that mates with a corresponding notch to prevent a movement (e.g., a rotational shift, a horizontal shift, a vertical shift, and/or the like) of the gasket 120 once the gasket is placed inside the case 140

A safety layer may be disposed between the jellyroll and the case of the battery cell (316). For example, one or more layers of material forming the safety layer 110, such as a polyhedral oligomeric silsesquioxane (POSS) and/or the like, may be disposed on an exterior surface of the jellyroll 130 and/or an interior surface of the case 140. The safety layer 110 may be applied by a variety of techniques including, for example, coating (e.g., micro-gravure coating, slot die coating, reverse roll coating), spraying, deposition (e.g., vapor deposition, electron beam deposition, ion assistant deposition, atomic layer deposition), and/or the like. Moreover, in some cases, the one or more layers of material forming the safety layer 110 may be subjected to one or more treatments including, for example, a drying treatment to remove solvent, a cross-linking treatment to rigidify the material forming the safety layer 110, a chemical treatment, a heat treatment, a radiation treatment (e.g., exposure to ultraviolet (UV) light, β-ray, X-ray), and/or the like.

An assembly including the lid, the pins coupled with the electrode tabs, the gasket placed around the pins coupled with the electrode tabs, and the jellyroll may be coupled with the case (318). For instance, an assembly including the lid 150, the pins 114 coupled with the electrode tabs 135, the gasket 120 placed around the pins 114 coupled with the electrode tabs 135, and the jellyroll 130 may be coupled with the case 140 with the jellyroll 130 and the gasket 120 being disposed inside the chamber that is formed by the case 140 and the lid 150. When the battery cell 100 is assembled, the safety layer 110 may be interposed between the jellyroll 130 and the case 140 to prevent contact between the jellyroll 130 and the case 140 in the event the case 140 becomes deformed. The jellyroll 130 inside the case 140 may be dried, for example, at 30° C. for 10 hours.

The case may be filled with electrolyte and sealed to complete the assembly of the battery cell (320). For example, the case 140 may be filled with a liquid electrolyte, a solid state electrolyte, a solid-liquid hybrid electrolyte and/or the like. Moreover, the lid 150 may be sealed to the case 140 to form a hermetically sealed chamber containing the gasket 120 and the jellyroll 130. As noted, the presence of the gasket 120 may protect the feedthroughs from damage caused by the electromagnetic energy that may be used to seal the lid 150 to the case 140. In some cases, the assembled battery cell 100 may also be aged, such as for 36 hours (or a different quantity of time).

### Example Safety Layer I

In some implementations of the current subject matter, the safety layer 110 may be formed by dissolving 1 gram of EP0409 Nanosilica Dispersion Epoxy (POSS) into 50 grams of tetrahydrofuran (THF). Furthermore, 5 grams of poly acrylic monomer can be added to the Nanosilica Dispersion Epoxy (POSS) solution as well as 50 grams of nano sized calcium carbonate (CaCO₃). The resulting slurry may be disposed on the surface of the metal case 140 and/or the surface of the jellyroll 130 of the battery cell 100. An ultraviolet (UV) light and a heating zone may be set up during the diposition of the safety layer 110 in order to treat the safety layer 110 disposed on the surface of the metal case 140 and/or the surface of the jellyroll 130.

### Example Safety Layer II

In some implementations of the current subject matter, the safety layer 110 may be formed by dissolving 1 gram of MA0735 Methacryl POSS Cage Mixture (POSS) into 50 grams of tetrahydrofuran (THF) and mixing 5 grams of poly acrylic monomer into the resulting solution. Furthermore, 50 grams of nano sized CaCO3 and 0.1 grams of an initiator may be added to solution to form a slurry. The slurry may be disposed on the surface of the metal case 140 and/or the surface of the jellyroll 130 of the battery cell 100. An ultraviolet (UV) light and a heating zone may be set up during the diposition of the safety layer 110 in order to treat the safety layer 110 disposed on the surface of the metal case 140 and/or the surface of the jellyroll 130.

### Example Safety Layer III

In some implementations of the current subject matter, the safety layer 110 may be formed by dissolving 0.8 grams TF-4000 into 8 grams of N-Methyl-2-pyrrolidone (NMP) to form a solution that is then combined with a solution formed by mixing 4.8 grams of polyvinylidene difluoride (PVDF) with 55 grams of N-Methyl-2-pyrrolidone (NMP). The resulting slurry can be mixed with 34.08 grams of nano calcium carbonate (CaCO₃) for 20 minutes at 5000 revolutions per minute. Furthermore, the slurry may be disposed on the surface of the metal case 140 and/or the surface of the jellyroll 130 of the battery cell 100 using an automatic coating machine with a first heat zone set to approximately 135° C. and a second heat zone set to approximately 165° C. to remove the solvent N-Methyl-2-pyrrolidone (NMP) and form a dried solid with a loading of approximately 0.7 milligrams per square centimeter (mg/cm²).

### Example Battery Cell I

In some implementations of the current subject matter, the battery cell 100 may be formed to include a single layer of the safety layer 110. The safety layer 110 may include 10 grams of TF-4000 poly imide amide, which may be mixed in a 500-milliliter stainless steel container with 100 grams of a solvent (e.g., N-Methyl-2-pyrrolidone (NMP) and/or the like) for 6 hours at 1000 revolutions per minute to form a solution. The solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The solution disposed the interior surface of the case 140 may be dried in a 60° C. convection oven for 24 hours to remove the solvent. The resulting safety layer 110 may have a loading of approximately 1.5 milligrams per square centimeter. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell II

In some implementations of the current subject matter, the battery cell 100 may be formed to include a single layer of the safety layer 110, which may be further formed to include a fire retardant. The safety layer 110 may include 10 grams of TF-4000 poly imide amide, which may be mixed in a 500-milliliter stainless steel container with 100 grams of a solvent (e.g., Methyl-2-pyrrolidone (NMP) and/or the like) for 6 hours at 1000 revolutions per minute to form a solution. A fire retardant, such as 80 grams of calcium carbonate (CaCO₃) nano particles may be added to the solution and mixed 3000 revolutions per minute for 4 hours. The solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The solution disposed the interior surface of the case 140 may be dried in a 60° C. convection oven for 24 hours to remove the solvent. The resulting safety layer 110 may have a loading of approximately 1.5 milligrams per square centimeter. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell III

In some implementations of the current subject matter, the battery cell 100 may be formed to include a single layer of the safety layer 110, which may be further formed to include a fire retardant and a conductive additive. The presence of the conductive additive in the safety layer 110 may serve to regulate current flow between the jellyroll 130 (e.g., the negative electrode and/or the positive electrode) and the case 140 in the event of an internal short. The safety layer 110 may include 10 grams of TF-4000 poly imide amide, which may be mixed in a 500-milliliter stainless steel container with 100 grams of a solvent (e.g., N-Methyl-2-pyrrolidone (NNW) and/or the like) for 6 hours at 1000 revolutions per minute to form a solution. A fire retardant, such as 80 grams of calcium carbonate (CaCO₃) nano particles may be added to the solution and mixed 3000 revolutions per minute for 4 hours. Moreover, 1 gram of a conductive additive, such as carbon black, may be added to the solution. The resulting solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The solution disposed the interior surface of the case 140 may be dried in a 60° C. convection oven for 24 hours to remove the solvent. The resulting safety layer 110 may have a loading of approximately 1.5 milligrams per square centimeter. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell IV

In some implementations of the current subject matter, the battery cell 100 may be formed to include a single layer of the safety layer 110, which may be further formed to include a binder and a fire retardant. The safety layer 110 may include 10 grams of TF-4000 poly imide amide and 2 grams of a binder (e.g., polyvinylidene fluoride (PVDF) and/or the like), which may be mixed in a 500-milliliter stainless steel container with 100 grams of a solvent (e.g., N-Methyl-2-pyrrolidone (NNW) and/or the like) for 6 hours at 1000 revolutions per minute to form a solution. A fire retardant, such as 80 grams of calcium carbonate (CaCO₃) nano particles may be added to the solution and mixed 3000 revolutions per minute for 4 hours. The solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The solution disposed the interior surface of the case 140 may be dried in a 60° C. convection oven for 24 hours to remove the solvent. The resulting safety layer 110 may have a loading of approximately 1.5 milligrams per square centimeter. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell V

In some implementations of the current subject matter, the battery cell 100 may be formed to include a single layer of the safety layer 110, which may be formed to include a fire retardant. Moreover, the safety layer 110 may be formed from a variety of solvents. For example, the safety layer 110 may include 5 grams of carboxymethyl cellulose (CMC), which may be mixed in a 500-milliliter stainless steel container with 294 grams of a solvent (e.g., water) for 6 hours at 1000 revolutions per minute to form a solution. A fire retardant, such as 50 grams of sodium carbonate (NaCO₃) nano particles may be added to the solution and mixed 3000 revolutions per minute for 4 hours. The solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The solution disposed the interior surface of the case 140 may be dried in a 60° C. convection oven for 24 hours to remove the solvent. The resulting safety layer 110 may have a loading of approximately 1.5 milligrams per square centimeter. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell VI

In some implementations of the current subject matter, the battery cell 100 may be formed to include a single layer of the safety layer 110, which may be formed to include a fire retardant. Moreover, the safety layer 110 may be formed from a variety of binders. For example, the safety layer 110 may include 5 grams of crosslinked polycrylic acid (Carbopol 940), which may be mixed in a 500-milliliter stainless steel container with 294 grams of a solvent (e.g., water) and 1 gram of sodium hydroxide (NaOH) for 6 hours at 1000 revolutions per minute to form a solution. A fire retardant, such as 50 grams of sodium carbonate (NaCO₃) nano particles may be added to the solution and mixed 3000 revolutions per minute for 4 hours. The solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The solution disposed the interior surface of the case 140 may be dried in a 60° C. convection oven for 24 hours to remove the solvent. The resulting safety layer 110 may have a loading of approximately 1.5 milligrams per square centimeter. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell VII

In some implementations of the current subject matter, the battery cell 100 may be formed to include multiple layers of the safety layer 110. For example, the safety layer 110 may include a first layer and a second layer, with the first layer interposed between the interior surface of the case 140 and the second layer. The first layer may be configured to release water while the second layer may be configured to make direct contact with the electrolyte included in the battery cell 100. The second layer will prevent the first layer (with water) to contact the moisture sensitive electrolyte under the normal situation so that the first layer with water will not damage the cell performance in the normal condition. The first layer can release the water to extinguish the fire when the can is crushed or damaged. The first is the safety layer that will release fire extinguish like the water to eliminate the potential ignition when the temperature of the cell goes up or when it contacts the electrolyte directly. Therefore, the first layer should be protected from contacting the electrolyte under the normal operation by the second layer to avoid the first layer reaction with the electrolyte, which will damage the battery.

The first layer of the safety layer 110 may include 20 grams of sodium metasilicate nonahydrate, which may be mixed in a 500-milliliter stainless steel container with 200 grams of a first solve (e.g., water) to form a first solution. A fire retardant, such as 80 grams of calcium carbonate (CaCO₃) nano particles may be added to the first solution and mixed 3000 revolutions per minute for 4 hours. The second layer of the safety layer 110 may include 10 grams of TF-4000 poly imide amide, which may be mixed in a 500-milliliter stainless steel container with 100 grams of a second solvent (e.g., N-Methyl-2-pyrrolidone (NMP)) for 6 hours at 1000 revolutions per minute to form a second solution. The first solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The first solution disposed the interior surface of the case 140 may be dried in a 60° C. convection oven for 24 hours to remove the solvent and achieve a loading of approximately 1.5 milligrams per square centimeter. The second solution may be disposed on the surface of the first layer of the safety layer 110, for example, by coating, spraying, deposition, and/or the like, before being dried in a 60° C. convection oven for 24 hours to remove the solvent and achieve a loading of approximately 1.5 milligrams per square centimeter.

A continuity tester (e.g., Model PB-1 and/or the like) may be used for verify the integrity of the safety layer 110, which includes the first layer interposed between the second layer and the interior surface of the case 140. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell VIII

In some implementations of the current subject matter, the battery cell 100 may be formed to include a single layer of the safety layer 110, which may be formed by disposing a commercial spray product, such as Gorilla crystal clear waterproof asphalt toluene/methyl acetate solution, on the interior surface of the case 140. The case 140 may be a prismatic aluminum can measuring 6.5 millimeters thick, 33.8 millimeters wide, and 49 millimeters high. The commercial spray product may be dried naturally for 24 hours to remove solvents (e.g., water) before a continuity tester (e.g., Model PB-1 and/or the like) may be used for verifying the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell IX

In some implementations of the current subject matter, the battery cell 100 may be formed to include a single layer of the safety layer 110, which may be formed by disposing a silicone spray product on the interior surface of the case 140. The case 140 may be a prismatic aluminum can measuring 6.5 millimeters thick, 33.8 millimeters wide, and 49 millimeters high. The commercial spray product may be dried naturally for 24 hours to remove solvents (e.g., water) before a continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell X

In some implementations of the current subject matter, the battery cell 100 may be formed to include a single layer of the safety layer 110, which may be formed by disposing a urethane spray product on the interior surface of the case 140. The case 140 may be a prismatic aluminum can measuring 6.5 millimeters thick, 33.8 millimeters wide, and 49 millimeters high. The commercial spray product may be dried naturally for 24 hours to remove solvents (e.g., water) before a continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell XI

In some implementations of the current subject matter, the battery cell 100 may be formed to include a single layer of the safety layer 110, which may be formed by disposing a commercial acrylic spray product on the interior surface of the case 140. The case 140 may be a prismatic aluminum can measuring 6.5 millimeters thick, 33.8 millimeters wide, and 49 millimeters high. The commercial spray product may be dried naturally for 24 hours to remove solvents (e.g., water) before a continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell XII

In some implementations of the current subject matter, the battery cell 100 may be formed to include a single layer of the safety layer 110 formed to include glass fiber, carbon fiber, and synthetic fibers such as Kevlar fiber (aramid fiber) rayon, polyester and other similar plastic fibers. The safety layer 110 may include 8 grams of TF-4000 poly imide amide and 2 grams polyvinylidene fluoride (PVDF), which may be mixed in a 500-milliliter stainless steel container with 100 grams of a solvent (e.g., N-Methyl-2-pyrrolidone (NMP) and/or the like) for 6 hours at 1000 revolutions per minute to form a solution. In addition, 8 grams of Kevlar fiber powder may be added to the solution and mixed at 3000 revolutions per minute for 4 hours. The resulting solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The solution disposed the interior surface of the case 140 may be dried in a 60° C. convection oven for 24 hours to remove the solvent. The resulting safety layer 110 may have a loading of approximately 1.5 milligrams per square centimeter. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell XIII

In some implementations of the current subject matter, the battery cell 100 may be formed to include a single layer of the safety layer 110, which may be a Kevlar sheet that is compressed to the interior surface of the case 140. The case 140 may be a prismatic aluminum can measuring 6.5 millimeters thick, 33.8 millimeters wide, and 49 millimeters high. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell XIV

In some implementations of the current subject matter, the interior surface of the case 140 may be corrugated and the safety layer 110 may be formed by disposing a solution including a fire retardant (e.g., terphenyl phosphate), a binder (e.g., polyvinylidene difluoride (PVDF)) dissolved in a solvent (e.g., N-Methyl-2-pyrrolidone (NMP)) into one or more voids of corrugated surface. The case 140 may be dried at 60° C. to remove the solvent from the mixture forming the safety layer 110. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. The jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell XV

In some implementations of the current subject matter, the battery cell 100 may be formed to include a single layer of the safety layer 110. The safety layer 110 may include 10 grams of TF-4000 poly imide amide, which may be mixed in a 500-milliliter stainless steel container with 100 grams of a solvent (e.g., N-Methyl-2-pyrrolidone (NMP) and/or the like) for 6 hours at 1000 revolutions per minute to form a solution. The solution may be disposed on the interior surface of the case 140 (e.g., a prismatic aluminum can measuring 6.5 millimeters thick, 33.8 millimeters wide, and 49 millimeters high) by coating, spraying, deposition, and/or the like. The interior surface of the case 140 may be formed from a corrugated metal such as aluminum (Al). The solution disposed the interior surface of the case 140 may be dried in a 60° C. convection oven for 24 hours to remove the solvent and achieve a loading of approximately 1.5 milligrams per square centimeter. A continuity tester (e.g., Model PB-1 and/or the like) may be used for verify the integrity of the safety layer 110. For example, the case 140 coated with the safety layer 110 may be ready for subsequent assembly when the continuity tester indicates that no electrical path exists inside the case 140. The jellyroll 130 (or jellyflat in the case of a prismatic cell), which may include a positive electrode (e.g., a lithium nickel manganese cobalt oxide electrode), a separator, and a negative electrode (e.g., graphite electrode), may be formed either stacking or winding. The resulting jellyroll 130 may be 30 millimeter wide, 46 millimeter high, and 5.9 millimeter thick. Once the case 140 is ready, the jellyroll 130 may be inserted into the case 140 with a top insulator placed on top of the jellyroll 130 before the lid 150 is laser sealed on top of the case 140. The battery cell 100 may be dried at 80° C. for 24 hours before the battery cell 100 is filled with 4 grams of electrolyte, for example, through an aperture in the sealed case 140. The aperture may subsequently be sealed with a steel ball by laser. The battery cell 100 may be aged at room temperature for 24 hours before being charged to 4.2 volts at 0.1 amperes, at which point the battery cell is ready for testing and/or use.

### Example Battery Cell Using Strong Electrodes XVI

In some implementations of the current subject matter, a poly-p-phenylene terephthalamide solution or fiber suspension solution may be formed by mixing 20 grams (2% by weight) of calcium chloride (CaCl₂) in 951.4 mL (980 g, 98% by weight) of N-Methyl-2-pyrrolidone (NMP). The calcium chloride may be stirred in the solution until dissolved. Moreover, 20 grams of poly-p-phenylene terephthalamide or Aramid fiber may be added the resulting calcium chloride solution and stirred until dissolved at 125° C. The solution may be yellow or brown in color depending on the quantity of Aramid fiber dissolved or dispersed therein.

The positive electrode of the battery cell may be formed by first preparing an electrode slurry. For example, 2 grams of methacryl polyhedral oligomeric silsesquioxane (POSS) cage mixture and 10 grams of polyvinylidene difluoride (PVDF) may be added to half of calcium chloride solution and mixed by being stirred at 2000 rpm for six hours before 10 grams of carbon black is added and the resulting solution is mixed at 3000 rpm for 60 minutes. Thereafter, 500 grams of LiNi_{0.6}Co_{0.2}Mn_{0.2}O₂ may be added to the solution and mixed for 2 hours at 3000 rpm before the resulting slurry is coated onto aluminum (Al) foil (e.g., 16×160 millimeter) using a coater having a first zone set to 110° C. with ultraviolet light and a second zone set to 140° C. The coater may be set to operate at 0.8 meter per minute to achieve a loading of 20 milligrams per square centimeter. The positive electrode of the battery cell may be formed by being compressed to about 126 millimeters by a calendaring machine then die-cut to 33 millimeter wide and 57 millimeter long for stacking during cell production.

The slurry for the negative electrode of the battery cell may be prepared by adding 2 grams of methacryl polyhedral oligomeric silsesquioxane (POSS) and 30 grams of polyvinylidene difluoride (PVDF) into the other half of the calcium chloride solution and stirring at 2000 rpm for six hours before adding 10 grams of carbon black and mixing at 3000 rpm for 60 min. Thereafter, 500 grams of graphite may be added and mixed for 2 hours at 3000 rpm before the resulting slurry is coated onto 8 mm copper (Cu) foil (e.g., 8×160 millimeters) using a coater having a first zone set to 110° C. with ultraviolet light and a second zone set to 140° C. The coater may be further set to operate at 0.8 meter per minute to achieve a loading of 10 milligrams per square centimeter. The negative electrode of the battery cell may be formed by being compressed to about 140 millimeters then die-cut to 34 millimeters wide and 58 millimeters long for stacking the cell production.

The battery cell may be formed by stacking the positive and negative electrodes (20 pieces of positive and 21 pieces of negative electrodes) with a separator interposed therebetween. The resulting jelly flat may be placed into a pouch and dried at 80° C. for 24 hours in a vacuum oven (reading −30). About 4 grams of electrolyte may be placed into the pouch before the pouch is sealed at 190° C. The finished battery cell may be aged at room temperature for 24 hours before being charged to 4.2 volts at C/50 and discharged to 3 volts at C/20 rate. The cell battery is then aged at room temperature for 21 days.

### Example Battery Cell Using Strong Electrodes XVII

In some implementations of the current subject matter, a poly-p-phenylene terephthalamide solution or fiber suspension solution may be formed by mixing 20 grams (2% by weight) of calcium chloride (CaCl₂) in 951.4 mL (980 g, 98% by weight) of N-Methyl-2-pyrrolidone (NMP). The calcium chloride may be stirred in the solution until dissolved. Moreover, 20 grams of poly-p-phenylene terephthalamide or Aramid fiber may be added the resulting calcium chloride solution and stirred until dissolved at 125° C. The solution may be yellow or brown in color depending on the quantity of Aramid fiber dissolved or dispersed therein.

The positive electrode of the battery cell may be formed by first preparing an electrode slurry. For example, 2 grams of glycidyllsooctyl polyhedral oligomeric silsesquioxane (POSS) and 10 grams of polyvinylidene difluoride (PVDF) may be added to half of calcium chloride solution and stirred at 2000 rpm for six hours before 10 grams of carbon black is added and the resulting solution is mixed at 3000 rpm for 60 minutes. Thereafter, 500 grams of LiNi_{0.6}Co_{0.2}Mn_{0.2}O₂ may be added to the solution and mixed for 2 hours at 3000 rpm before the resulting slurry is coated onto aluminum (Al) foil (e.g., 16×160 millimeter) using a coater having a first zone set to 110° C. with ultraviolet light and a second zone set to 140° C. The coater may be set to operate at 0.8 meter per minute to achieve a loading of 20 milligrams per square centimeter. The positive electrode of the battery cell may be formed by being compressed to about 126 millimeters by a calendaring machine then die-cut to 33 millimeter wide and 57 millimeter long for stacking during cell production.

The slurry for the negative electrode of the battery cell may be prepared by adding 2 grams of glycidyllsooctyl polyhedral oligomeric silsesquioxane (POSS) and 30 grams of polyvinylidene difluoride (PVDF) into the other half of the calcium chloride solution and stirring at 2000 rpm for six hours before adding 10 grams of carbon black and mixing at 3000 rpm for 60 min. Thereafter, 500 grams of graphite may be added and mixed for 2 hours at 3000 rpm before the resulting slurry is coated onto 8 mm copper (Cu) foil (e.g., 8×160 millimeters) using a coater having a first zone set to 110° C. with ultraviolet light and a second zone set to 140° C. The coater may be further set to operate at 0.8 meter per minute to achieve a loading of 10 milligrams per square centimeter. The negative electrode of the battery cell may be formed by being compressed to about 140 millimeters then die-cut to 34 millimeters wide and 58 millimeters long for stacking the cell production.

The battery cell may be formed by stacking the positive and negative electrodes (20 pieces of positive and 21 pieces of negative electrodes) with a separator interposed therebetween. The resulting jelly flat may be placed into a pouch and dried at 80° C. for 24 hours in a vacuum oven (reading −30). About 4 grams of electrolyte may be placed into the pouch before the pouch is sealed at 190° C. The finished battery cell may be aged at room temperature for 24 hours before being charged to 4.2 volts at C/50 and discharged to 3 volts at C/20 rate. The cell battery is then aged at room temperature for 21 days.

### Example Battery Cell Using Strong Electrodes XVIII

In some implementations of the current subject matter, a poly-p-phenylene terephthalamide solution or fiber suspension solution may be formed by mixing 20 grams (2% by weight) of calcium chloride (CaCl₂) in 951.4 mL (980 g, 98% by weight) of N-Methyl-2-pyrrolidone (NMP). The calcium chloride may be stirred in the solution until dissolved. Moreover, 20 grams of poly-p-phenylene terephthalamide or Aramid fiber may be added the resulting calcium chloride solution and stirred until dissolved at 125° C. The solution may be yellow or brown in color depending on the quantity of Aramid fiber dissolved or dispersed therein.

The positive electrode of the battery cell may be formed by first preparing an electrode slurry. For example, 2 grams of TrisilanolPhenyl polyhedral oligomeric silsesquioxane (POSS) (C₄₂H₃₈O₁₂Si₇) and 10 grams of polyvinylidene difluoride (PVDF) may be added to half of calcium chloride solution and stirred at 2000 rpm for six hours before 10 grams of carbon black is added and the resulting solution is mixed at 3000 rpm for 60 minutes. Thereafter, 500 grams of LiNi_{0.6}Co_{0.2}Mn_{0.2}O₂ may be added to the solution and mixed for 2 hours at 3000 rpm before the resulting slurry is coated onto aluminum (Al) foil (e.g., 16×160 millimeter) using a coater having a first zone set to 110° C. with ultraviolet light and a second zone set to 140° C. The coater may be set to operate at 0.8 meter per minute to achieve a loading of 20 milligrams per square centimeter. The positive electrode of the battery cell may be formed by being compressed to about 126 millimeters by a calendaring machine then die-cut to 33 millimeter wide and 57 millimeter long for stacking during cell production.

The slurry for the negative electrode of the battery cell may be prepared by adding 2 grams of TrisilanolPhenyl polyhedral oligomeric silsesquioxane (POSS) (C₄₂H₃₈O₁₂Si₇) and 30 grams of polyvinylidene difluoride (PVDF) into the other half of the calcium chloride solution and stirring at 2000 rpm for six hours before adding 10 grams of carbon black and mixing at 3000 rpm for 60 min. Thereafter, 500 grams of graphite may be added and mixed for 2 hours at 3000 rpm before the resulting slurry is coated onto 8 mm copper (Cu) foil (e.g., 8×160 millimeters) using a coater having a first zone set to 110° C. with ultraviolet light and a second zone set to 140° C. The coater may be further set to operate at 0.8 meter per minute to achieve a loading of 10 milligrams per square centimeter. The negative electrode of the battery cell may be formed by being compressed to about 140 millimeters then die-cut to 34 millimeters wide and 58 millimeters long for stacking the cell production.

The battery cell may be formed by stacking the positive and negative electrodes (20 pieces of positive and 21 pieces of negative electrodes) with a separator interposed therebetween. The resulting jelly flat may be placed into a pouch and dried at 80° C. for 24 hours in a vacuum oven (reading −30). About 4 grams of electrolyte may be placed into the pouch before the pouch is sealed at 190° C. The finished battery cell may be aged at room temperature for 24 hours before being charged to 4.2 volts at C/50 and discharged to 3 volts at C/20 rate. The cell battery is then aged at room temperature for 21 days.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A battery cell, comprising:
a jellyroll including a first electrode, a second electrode, and a separator interposed between the first electrode and the second electrode;
a case; and
a safety layer interposed between the jellyroll and the case, the safety layer configured to prevent contact between the jellyroll and the case.

2. The battery cell of claim 1, wherein the safety layer is configured to stretch to accommodate one or more deformations in the case such that the safety layer remains interposed between the jellyroll and the case when the case is bent towards the jellyroll.

3. The battery cell of claim 1, wherein the safety layer comprises one or more of polyhedral oligomeric silsesquioxane (POSS), poly imide amide, carboxymethyl cellulose (CMC), crosslinked polycrylic acid, sodium metasilicate nonahydrate, silicone, urethane, acrylic, and Kevlar.

4. The battery cell of claim 1, wherein the safety layer includes a conductive additive.

5. The battery cell of claim 4, wherein the conductive additive comprises carbon black.

6. The battery cell of claim 1, wherein the safety layer includes a fire retardant.

7. The battery cell of claim 6, wherein the fire retardant comprises one or more of calcium carbonate (CaCO₃), sodium carbonate (NaCO₃), and terphenyl phosphate.

8. The battery cell of claim 1, wherein the safety layer includes a binder.

9. The battery cell of claim 8, wherein the binder comprises polyvinylidene fluoride (PVDF).

10. The battery cell of claim 1, wherein the safety layer includes a solvent.

11. The battery cell of claim 10, wherein the binder comprises one or more of water and N-Methyl-2-pyrolidone (NMP).

12. The battery cell of claim 1, wherein the safety layer includes a first layer and a second layer, wherein the first layer is interposed between an interior surface of the case and the second layer, and wherein the first layer is configured to release water while the second layer is configured to make direct contact with an electrolyte included in the battery cell.

13. The battery cell of claim 12, wherein the first layer is formed from a different solvent than the second layer.

14. The battery cell of claim 12, wherein the first layer includes sodium metasilicate nonahydrate dissolved in water, and wherein the second layer includes poly imide amide dissolved in N-Methyl-2-pyrrolidone (NMP).

15. The battery cell of claim 1, wherein the safety layer is disposed on an exterior surface of the jellyroll and/or an interior surface of the case.

16. The battery cell of claim 1, wherein an interior surface of the case is corrugated, and wherein the safety layer is formed by disposing a solution of materials comprising the safety layer in one or more voids of the corrugated interior surface of the case.

17. The battery cell of claim 1, further comprising:
a lid including a first pin and a second pin, the case configured to form a chamber when sealed with the lid, the jellyroll being disposed inside the chamber, the jellyroll including a negative electrode tab configured to couple with the first pin to form a negative terminal of the battery cell, and the jellyroll further including a positive electrode tab configured to couple with the second pin to form a positive terminal of the battery cell; and
a gasket configured to at least partially encase each of the negative electrode tab and the positive electrode tab to prevent a contact between the negative electrode tab, the positive electrode tab, and/or the case of the battery cell.

18. The battery cell of claim 1, further comprising:
a first current collector coupled with the first electrode;
a second current collector coupled with the second electrode; and
an electrolyte.

19. The battery cell of claim 1, wherein the battery cell comprises a cylindrical cell, a prismatic cell, a pouch cell, or a button cell.

20. The battery cell of claim 1, wherein the first electrode and/or the second electrode comprise a poly-p-phenylene terephthalamide or an aramid dissolved and/or dispersed in a polyhedral oligomeric silsesquioxane (POSS).
